(19) United States
(12) Patent Application Publication
(10) Pub. No.: US 2019/0212444 A1
(43) Pub. Date: Jul. 11, 2019

(54) DETECTION DEVICE, DETECTION METHOD, AND RECORDING MEDIUM

(71) Applicant: Panasonic Intellectual Property Management Co., Ltd., Osaka (JP)

(72) Inventors: SHINYA OGAWA, Kanagawa (JP); TAKANORI UEDA, Kanagawa (JP); TATSUAKI YAMAGISHI, Kanagawa (JP)

(21) Appl. No.: 16/357,481

(22) Filed: Mar. 19, 2019

Related U.S. Application Data
(63) Continuation of application No. PCT/JP2017/034611, filed on Sep. 26, 2017.

(30) Foreign Application Priority Data
Sep. 30, 2016 (JP) 2016-194597

(51) Int. Cl. G01S 15/93; G01S 7/527; G01S 15/08

(52) U.S. Cl. CPC G01S 15/931; G01S 2015/938; G01S 15/08; G01S 7/527

(57) ABSTRACT

A detection device includes a transceiver and a detector. The transceiver causes an ultrasonic sensor used in a vehicle to alternately transmit a first transmission wave having a first amplitude level and a second transmission wave having a second amplitude level that is larger than the first amplitude level. The transceiver receives, from the ultrasonic sensor, a first received signal of the first transmission wave and a second received signal of the second transmission wave. The detector detects an obstacle based on the first received signal or the second received signal having a reception level larger than a predetermined threshold. The detector detects the obstacle based on the second received signal that does not include a second road surface reflected wave out of the second received signal.

### TECHNICAL FIELD

The present disclosure relates to a detection device, a detection method, and a detection program for detecting an obstacle.

### BACKGROUND ART

Conventionally, there are known obstacle detection devices that each detect an obstacle existing rearward of a vehicle such as an automobile by using an ultrasonic sensor (sonar) mounted on a rear portion of the vehicle. The ultrasonic sensor transmits an ultrasonic wave (transmission wave) rearward of the vehicle. The obstacle detection device receives a reflected wave obtained by the ultrasonic wave hitting the obstacle and being reflected, and detects the obstacle based on the reflected wave.

In such an obstacle detection device, when extending a distance of coverage of the transmission wave, it is considered to enlarge a transmission wave voltage gain and to increase a number of transmission wave pulses. However, when the transmission wave voltage gain is enlarged, the transmission wave hits a road surface and is reflected, and the obstacle detection device erroneously detects an obstacle on the road surface based on the reflected wave only from the road surface.

Therefore, for example, PTL 1 discloses a technique to detect an obstacle existing on a road surface by comparing an average of a reflected wave from the road surface where the obstacle exists with an average of the reflected wave only from the road surface.

### CITATION LIST

### Patent Literature

PTL 1: Unexamined Japanese Patent Publication No. H3-243413

### SUMMARY OF THE INVENTION

The present disclosure provides a detection device, a detection method, and a detection program that can detect an obstacle in a wider range and detect an obstacle on a road surface accurately.

A detection device according to the present disclosure includes a transceiver and a detector. The transceiver causes an ultrasonic sensor used in a vehicle to alternately transmit a first transmission wave having a first amplitude level and a second transmission wave having a second amplitude level that is larger than the first amplitude level. The transceiver receives, from the ultrasonic sensor, a first reflected wave of the first transmission wave and a second reflected wave of the second transmission wave that are received by the ultrasonic sensor. The detector detects an obstacle based on the first reflected wave or the second reflected wave having a reception level larger than a predetermined threshold. The first amplitude level is set to make the reception level of a first road surface reflected wave reflected by a road surface out of the first reflected wave less than or equal to the predetermined threshold. The second amplitude level is set to make the reception level of a second road surface reflected wave reflected by a partial area of the road surface out of the second reflected wave larger than the predetermined threshold. The detector detects the obstacle based on the second reflected wave that does not include the second road surface reflected wave out of the second reflected wave.

A detection method according to the present disclosure includes a transmission and reception step and a detection step. The transmission and reception step includes: causing an ultrasonic sensor used in a vehicle to alternately transmit a first transmission wave having a first amplitude level and a second transmission wave having a second amplitude level that is larger than the first amplitude level. The transmission and reception step includes receiving, from the ultrasonic sensor, a first reflected wave of the first transmission wave and a second reflected wave of the second transmission wave that are received by the ultrasonic sensor. The detection step includes detecting an obstacle based on the first reflected wave or the second reflected wave having a reception level larger than a predetermined threshold. The first amplitude level is set to make the reception level of a first road surface reflected wave reflected by a road surface out of the first reflected wave less than or equal to the predetermined threshold. The second amplitude level is set to make the reception level of a second road surface reflected wave reflected by a partial area of the road surface out of the second reflected wave larger than the predetermined threshold. The detection step includes detecting the obstacle based on the second reflected wave that does not include the second road surface reflected wave out of the second reflected wave.

A detection program according to the present disclosure causes a computer to execute transmission and reception processing and detection processing. The transmission and reception processing includes causing an ultrasonic sensor used in a vehicle to alternately transmit a first transmission wave having a first amplitude level and a second transmission wave having a second amplitude level that is larger than the first amplitude level. The transmission and reception processing includes receiving, from the ultrasonic sensor, a first reflected wave of the first transmission wave and a second reflected wave of the second transmission wave that are received by the ultrasonic sensor. The detection processing includes detecting an obstacle based on the first reflected wave or the second reflected wave having a reception level larger than a predetermined threshold. The first amplitude level is set to make the reception level of a first road surface reflected wave reflected by a road surface out of the first reflected wave less than or equal to the predetermined threshold. The second amplitude level is set to make the reception level of a second road surface reflected wave reflected by a partial area of the road surface out of the second reflected wave larger than the predetermined threshold. The detection processing includes detecting the obstacle based on the second reflected wave that does not include the second road surface reflected wave out of the second reflected wave.

Note that modifications of aspects of the present disclosure modified between method, device, recording medium (including computer-readable non-transient recording medium), computer program, or the like are also effective as the aspects of the present disclosure.

The present disclosure allows detection of an obstacle in a wider range and detection of an obstacle on a road surface accurately.

### BRIEF DESCRIPTION OF DRAWINGS

FIG. 1 is a block diagram illustrating a configuration example of a detection device according to an exemplary embodiment of the present disclosure.

FIG. 2 is a conceptual diagram illustrating one example of coverage of a transmission wave according to the exemplary embodiment of the present disclosure.

FIG. 3 is a conceptual diagram illustrating a switching example of a transmission and reception mode according to the exemplary embodiment of the present disclosure.

FIG. 4 is a flowchart illustrating an operation example of the detection device according to the exemplary embodiment of the present disclosure.

FIG. 5 is a diagram illustrating one example of a position of an obstacle detected in a normal transmission and reception mode.

FIG. 6A is a diagram illustrating one example of the position of the obstacle detected in a long-distance transmission and reception mode.

FIG. 6B is a diagram illustrating one example of the position of the obstacle detected in the long-distance transmission and reception mode.

FIG. 7 is a conceptual diagram illustrating an example of continuation of the normal transmission and reception mode.

FIG. 8 is a conceptual diagram illustrating an example of continuation of the normal transmission and reception mode.

FIG. 9 is a conceptual diagram illustrating a switching example of a transmission and reception mode according to a modification of the present disclosure.

### DESCRIPTION OF EMBODIMENT

Prior to describing an exemplary embodiment of the present disclosure, a problem in a conventional technique will be briefly described. With the technique of PTL 1, when an average of a reflected wave from a road surface where an obstacle exists and an average of a reflected wave only from the road surface are equivalent, there is a possibility that the obstacle may be undetectable.

Hereinafter, the exemplary embodiment of the present disclosure will be described with reference to the drawings.

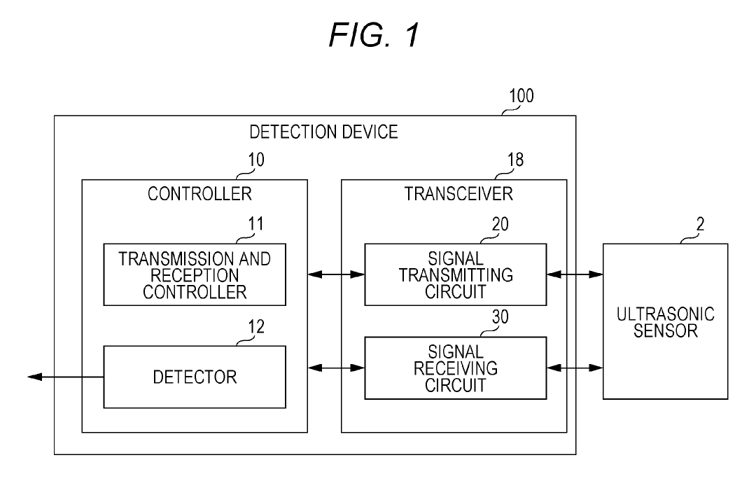

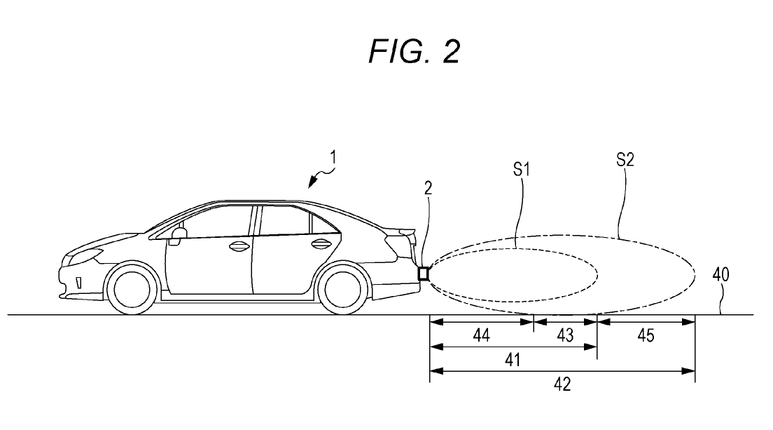

First, a configuration of detection device 100 according to the exemplary embodiment of the present disclosure will be described with reference to FIG. 1 and FIG. 2. FIG. 1 is a diagram illustrating a configuration example of detection device 100 according to the present exemplary embodiment.

Detection device 100 illustrated in FIG. 1 is mounted on vehicle 1 such as an automobile (refer to FIG. 2), and is electrically connected to ultrasonic sensor 2 mounted on vehicle 1. Ultrasonic sensor 2 is attached, for example, to a rear portion of vehicle 1 (for example, near a rear damper) as illustrated in FIG. 2. As illustrated in FIG. 1, detection device 100 includes controller 10 and transceiver 18. Controller 10 includes transmission and reception controller 11 and detector 12.

Transceiver 18 includes signal transmitting circuit 20 and signal receiving circuit 30. Ultrasonic sensor 2 transmits a transmission wave (ultrasonic wave). A reflected wave of the transmission wave reflected by an obstacle or a road surface (ultrasonic wave) is received. Ultrasonic sensor 2 converts the received reflected wave into a signal, and outputs the converted signal to transceiver 18. Signal receiving circuit 30 within transceiver 18 receives the signal output from transceiver 18. Signal receiving circuit 30 outputs the received signal. Detector 12 receives the received signal that is output by signal receiving circuit 30. Detector 12 regards the reflected wave having a reception level of the received signal input from signal receiving circuit 30 larger than a predetermined threshold as a target of obstacle detection processing, and outputs detection result information indicating an obstacle detection result to a predetermined device.

Transmission and reception controller 11 outputs a control signal to each of signal transmitting circuit 20 and signal receiving circuit 30. Transmission and reception controller 11 outputs a transmission wave voltage gain of the transmission wave to signal transmitting circuit 20, and outputs a reception wave signal gain to signal receiving circuit 30. Signal transmitting circuit 20 amplifies an amplitude level of the transmission wave (transmission level) according to the transmission wave voltage gain. Signal receiving circuit 30 amplifies the reception level of the received signal according to the reception wave signal gain.

Note that the present exemplary embodiment has described an example in which detection device 100 and ultrasonic sensor 2 are mounted on vehicle 1 (automobile), but detection device 100 and ultrasonic sensor 2 may be mounted on a movable body other than vehicle 1 (automobile).

In order to detect an obstacle rearward of vehicle 1, ultrasonic sensor 2 transmits an ultrasonic wave (hereinafter referred to as a transmission wave) rearward of vehicle 1. Ultrasonic sensor 2 then receives the ultrasonic wave obtained by the transmission wave hitting the obstacle and being reflected (hereinafter referred to as a reflected wave). The obstacle is, for example, an object such as a wall and a curbstone, or a creature such as a human and an animal.

Note that the present exemplary embodiment has described an example in which the transmission wave is transmitted rearward of vehicle 1, but the exemplary embodiment is not limited to this example. Ultrasonic sensor 2 may be mounted, for example, on a side or front of vehicle 1, and transmit the transmission wave sideward or frontward of vehicle 1.

In the present exemplary embodiment, ultrasonic sensor 2 transmits a first transmission wave (ultrasonic wave) and a second transmission wave (ultrasonic wave) alternately. Also, ultrasonic sensor 2 receives a first reflected wave of the first transmission wave (ultrasonic wave), and receives a second reflected wave of the second transmission wave (ultrasonic wave). The first transmission wave differs from the second transmission wave in coverage (details will be described later with reference to FIG. 2), and the second transmission wave is transmitted farther than the first transmission wave.

Hereinafter, processing for ultrasonic sensor 2 to transmit the first transmission wave and to receive the first reflected wave is referred to as a “normal transmission and reception mode” (one example of a first transmission and reception mode). Processing for ultrasonic sensor 2 to transmit the second transmission wave and to receive the second reflected wave is referred to as a “long-distance transmission and reception mode” (one example of a second transmission and reception mode).

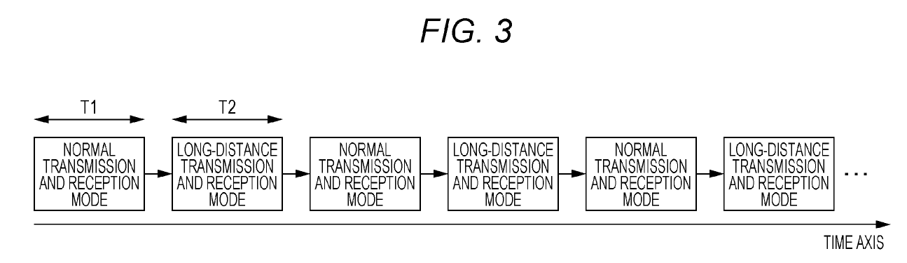

In the present exemplary embodiment, as illustrated in FIG. 3, detection device 100 alternately executes the normal transmission and reception mode and the long-distance transmission and reception mode. That is, detection device 100 repeats processing for switching to the long-distance transmission and reception mode after executing the normal transmission and reception mode for unit time T1, and switching to the normal transmission and reception mode after executing the long-distance transmission and reception mode for unit time T2 (for example, the same length as unit time T1).

Note that in FIG. 3, arrows between the normal transmission and reception mode and the long-distance transmission and reception mode are illustrated for convenience in order to illustrate switching order, and the arrows do not illustrate time intervals. That is, switching from the normal transmission and reception mode to the long-distance transmission and reception mode and switching from the long-distance transmission and reception mode to the normal transmission and reception mode are executed immediately, without any time intervals.

Further, the number of times that the detection device 100 transmits the transmission wave during the unit time T1 or T2 is not limited to one, and may be plural. By transmitting it multiple times, it is possible to prevent a malfunction due to erroneous detection of an obstacle at one time. [0024]

Here, one example of coverage of each of the first transmission wave and the second transmission wave will be described.

FIG. 2 is a conceptual diagram illustrating coverage of each of the first transmission wave and the second transmission wave. In FIG. 2, coverage S1 indicates coverage of the first transmission wave, and coverage S2 indicates coverage of the second transmission wave. As illustrated in FIG. 2, coverage S2 is wider and has a longer distance than coverage S1. That is, the amplitude level (transmission level) of the second transmission wave is larger than the amplitude level (transmission level) of the first transmission wave.

In FIG. 2, area 41 is an area of road surface 40 corresponding to coverage S1, and area 42 is an area of road surface 40 corresponding to coverage S2. Also, as illustrated in FIG. 2, area 41 includes areas 43 and 44, and area 42 includes areas 43, 44, and 45.

Area 43 (one example of a partial area) is included in coverage S2. Therefore, in the long-distance transmission and reception mode, the second transmission wave hits and is reflected by area 43. The second reflected wave includes the reflected wave that hits and is reflected by area 43 (hereinafter referred to as a road surface reflected wave).

The amplitude level of the second transmission wave is set to make the reception level of the reflected wave from area 43 (one example of a second road surface reflected wave) larger than a predetermined threshold (including zero, the same applies hereinafter). The amplitude level of the first transmission wave is set to make the reception level of the reflected wave of the first transmission wave from road surface 40 (one example of a first road surface reflected wave) less than or equal to the predetermined threshold.

However, when there is an obstacle in area 43 in the long-distance transmission and reception mode, the second reflected wave is a mixed wave of the reflected wave that hits the obstacle and is reflected, and the road surface reflected wave, and thus there is a possibility that obstacle detection accuracy decreases. Therefore, in the present exemplary embodiment, regardless of whether there is an obstacle in area 43, detection device 100 does not perform obstacle detection processing based on the second reflected wave from area 43 received in the long-distance transmission and reception mode (the second reflected wave including only the road surface reflected wave or the second reflected wave that is the mixed wave). In the present exemplary embodiment, the obstacle in area 43 is not detected in the long-distance transmission and reception mode, but is detected in the normal transmission and reception mode.

Area 43 described above is already known to detection device 100 (for example, detector 12). For example, a distance between ultrasonic sensor 2 and area 43, a length of area 43 in the vehicle traveling direction, and the like are already known to detection device 100.

Area 44 is an area closer to vehicle 1 than area 43 is, on road surface 40. As illustrated in FIG. 2, area 44 is an area corresponding to both coverage S1 and coverage S2, and thus the obstacle in area 44 is detected in both the normal transmission and reception mode and the long-distance transmission and reception mode.

Area 45 is an area farther from vehicle 1 than area 43 is, on road surface 40. As illustrated in FIG. 2, area 45 is an area corresponding to only coverage S2, and thus the obstacle in area 45 is not detected in the normal transmission and reception mode but is detected in the long-distance transmission and reception mode.

One example of coverage of each of the first transmission wave and the second transmission wave has been described above. FIG. 1 will be described again below.

As illustrated in FIG. 1, detection device 100 includes controller 10 and transceiver 18. Transceiver 18 includes signal transmitting circuit 20 and signal receiving circuit 30. Detection device 100 is, for example, an ultrasonic distance measurement electronic control unit (ECU). Transceiver 18 can be implemented, for example, as a signal transmitting and receiving circuit.

Controller 10 includes transmission and reception controller 11 and detector 12. Controller 10 includes, not illustrated in the figure, for example, a central processing unit (CPU), a storage medium such as a read only memory (ROM) storing a control program, a working memory such as a random access memory (RAM), and a communication circuit. Functions of transmission and reception controller 11 and detector 12 illustrated in FIG. 1 (details will be described later) are implemented by the CPU executing the control program. Instead of the functions of controller 10 being implemented by the CPU executing the control program, the functions may be implemented as dedicated circuitry such as a control circuit.

Transmission and reception controller 11 controls signal transmitting circuit 20 to alternately transmit the first transmission wave and the second transmission wave from ultrasonic sensor 2. For example, transmission and reception controller 11 outputs a control signal to each of signal transmitting circuit 20 and signal receiving circuit 30. The control signal that is output to signal transmitting circuit 20 includes, for example, at least one of an instruction on a transmission wave voltage gain (also referred to as a transmission gain) and an instruction on a change in number of transmission pulses. The control signal that is output to signal receiving circuit 30 includes, for example, an instruction on the reception wave signal gain (also referred to as a reception gain).

As described above, in the present exemplary embodiment, the first transmission wave and the second transmission wave that differ in coverage are alternately transmitted. Therefore, transmission and reception controller 11 instructs the transmission wave voltage gain of the first transmission wave (hereinafter referred to as a first transmission voltage gain), and the transmission wave voltage gain of the second transmission wave (hereinafter referred to as a second transmission wave voltage gain) to signal transmitting circuit 20. The second transmission wave voltage gain is larger than the first transmission wave voltage gain.

Alternatively, instead of the instructions on the first transmission wave voltage gain and the second transmission wave voltage gain, transmission and reception controller 11 may instruct the reception wave signal gain of the first reflected wave (hereinafter referred to as a first reception wave signal gain), and the reception wave signal gain of the second reflected wave (hereinafter referred to as a second reception wave signal gain) to signal receiving circuit 30. The second reception wave signal gain is larger than the first reception wave signal gain.

Alternatively, transmission and reception controller 11 may instruct the first transmission wave voltage gain and the second transmission wave voltage gain to signal transmitting circuit 20, and may instruct the first reception wave signal gain and the second reception wave signal gain to signal receiving circuit 30.

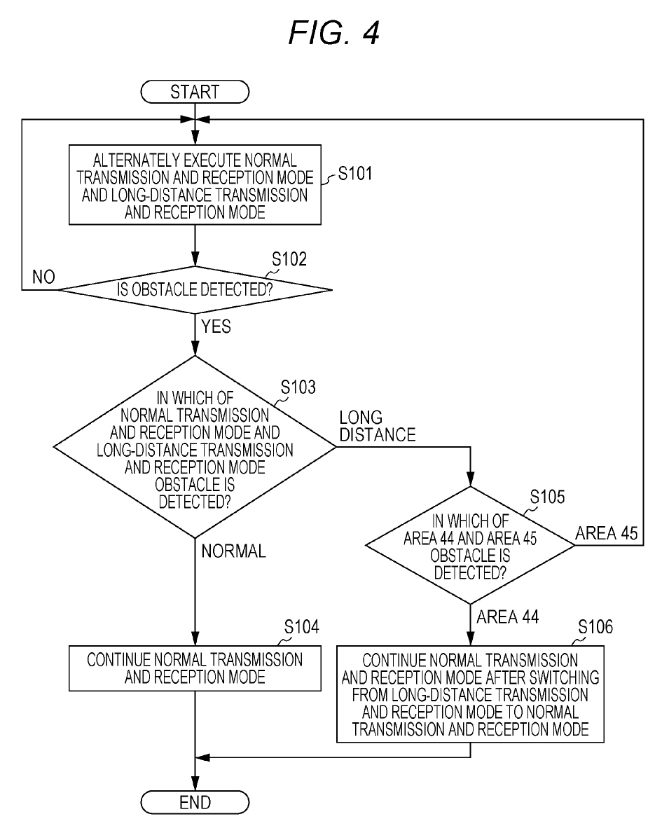

Transmission and reception controller 11 outputs a control signal for instructing continuation of the normal transmission and reception mode to each of signal transmitting circuit 20 and signal receiving circuit 30. Details will be described later with reference to a flowchart of FIG. 4.

Detector 12 detects the obstacle based on a received signal obtained by converting the reflected wave received from signal receiving circuit 30. Also, detector 12 calculates a distance between ultrasonic sensor 2 and the obstacle based on a speed of the transmission wave and time after transmitting the transmission wave until receiving the reflected wave. Based on the calculated distance and a position of area 43 which is already known, detector 12 can determine from which area (for example, either of areas 41 to 45) or from which space (for example, space above either of areas 41 to 45) the received reflected wave has come.

Note that in the present exemplary embodiment, detector 12 performs obstacle detection processing on the reflected wave with the reception level of the received signal larger than a predetermined threshold. On the other hand, detector 12 does not perform obstacle detection processing on the reflected wave with the reception level less than or equal to the predetermined threshold (including zero).

For example, when the reception level of the received signal obtained by converting the first reflected wave is equal to or larger than the predetermined threshold, detector 12 determines that the obstacle is above area 41. Based on the speed of the transmission wave and time after transmitting the transmission wave until receiving the reflected wave, detector 12 calculates the distance between ultrasonic sensor 2 and the obstacle above area 41.

For example, when the reception level of the received signal of the second reflected wave is larger than or equal to the predetermined threshold, detector 12 determines that the obstacle is above area 44 or area 45. In this case, by calculating the distance between ultrasonic sensor 2 and the obstacle and comparing the distance with the position of area 43 which is already known, detector 12 determines in which of area 44 or area 45 the obstacle is.

Detector 12 outputs the detection result information indicating the obstacle detection result (determination result described above) to a predetermined device. The predetermined device may be, for example, an ECU other than the ultrasonic distance measurement ECU (for example, an ECU that performs vehicle driving support), or may be a display device.

The detection result information may be, for example, information indicating only presence of the obstacle, or in addition to this information, the detection result information may include at least one of information indicating an area where the obstacle exists and information indicating the distance between the obstacle and ultrasonic sensor 2.

Signal transmitting circuit 20 controls ultrasonic sensor 2 to transmit the transmission wave based on the control signal received from transmission and reception controller 11.

For example, signal transmitting circuit 20 receives the control signal including instructions on the first transmission wave voltage gain and the second transmission wave voltage gain. Then, signal transmitting circuit 20 instructs ultrasonic sensor 2 to alternately perform processing for transmitting the transmission wave with the first transmission wave voltage gain (part of the normal transmission and reception mode), and processing for transmitting the generated transmission wave with the second transmission wave voltage gain (part of the long-distance transmission and reception mode). Ultrasonic sensor 2 that receives this instruction alternately transmits the first transmission wave and the second transmission wave.

For example, when signal transmitting circuit 20 receives the control signal including instructions on continuation of the normal transmission and reception mode, signal transmitting circuit 20 instructs ultrasonic sensor 2 to perform processing for transmitting the transmission wave continuously with the first transmission wave voltage gain. Ultrasonic sensor 2 that receives this instruction does not transmit the second transmission wave and transmits the first transmission wave continuously.

Signal receiving circuit 30 receives the first reflected wave and receives the second reflected wave from ultrasonic sensor 2. Then, signal receiving circuit 30 amplifies these reflected waves with the reception wave signal gain set in advance, performs filtering on the amplified reflected waves, and outputs resulting signals to controller 10.

For example, when signal receiving circuit 30 receives the control signal including the instructions on the first reception wave signal gain and the second reception wave signal gain from transmission and reception controller 11, signal receiving circuit 30 performs processing for amplifying the reflected wave with the first reception wave signal gain (part of the normal transmission and reception mode), and performs processing for amplifying the reflected wave with the second reception wave signal gain (part of the long-distance transmission and reception mode).

For example, when receiving the control signal including the instruction on continuation of the normal transmission and reception mode, signal receiving circuit 30 continuously performs processing for amplifying the reflected waves with the first reception wave signal gain.

The configuration of detection device 100 has been described above.

Next, an operation of detection device 100 will be described with reference to FIG. 4. FIG. 4 is a flowchart illustrating an operation example of detection device 100.

First, for example, as illustrated in FIG. 3, signal transmitting circuit 20 and signal receiving circuit 30 of transceiver 18 alternately execute the normal transmission and reception mode and the long-distance transmission and reception mode (step S101).

In a case where detector 12 detects no obstacle based on the reflected wave (step S102: NO), the flow returns to step S101. The case where detector 12 detects no obstacle is, for example, a case where both of a conversion signal of the first reflected wave and a conversion signal of the second reflected wave are less than or equal to a predetermined threshold, or a case where the conversion signal of the second reflected wave is larger than or equal to the predetermined threshold and the road surface reflected wave is included in the second reflected wave.

On the other hand, when detector 12 detects an obstacle based on the reflected wave of either the first reflected wave or the second reflected wave (step S102: YES), detector 12 outputs the detection result information to a predetermined device. Then, the flow proceeds to step S103.

Next, detector 12 determines in which of the normal transmission and reception mode and the long-distance transmission and reception mode the obstacle is detected (step S103). In other words, detector 12 determines based on which of the first reflected wave and the second reflected wave the obstacle is detected.

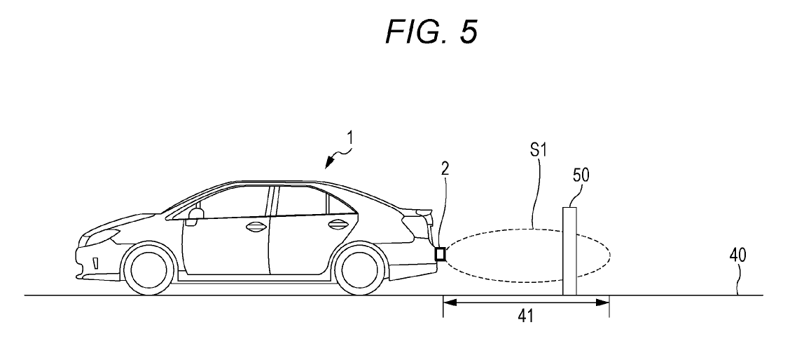

FIG. 5 is a diagram illustrating one example of the position of the obstacle detected in the normal transmission and reception mode. As illustrated in FIG. 5, when obstacle 50 is in area 41 (either of areas 43 and 44 illustrated in FIG. 2) in the normal transmission and reception mode, obstacle 50 in area 41 is detected based on the first reflected wave from obstacle 50.

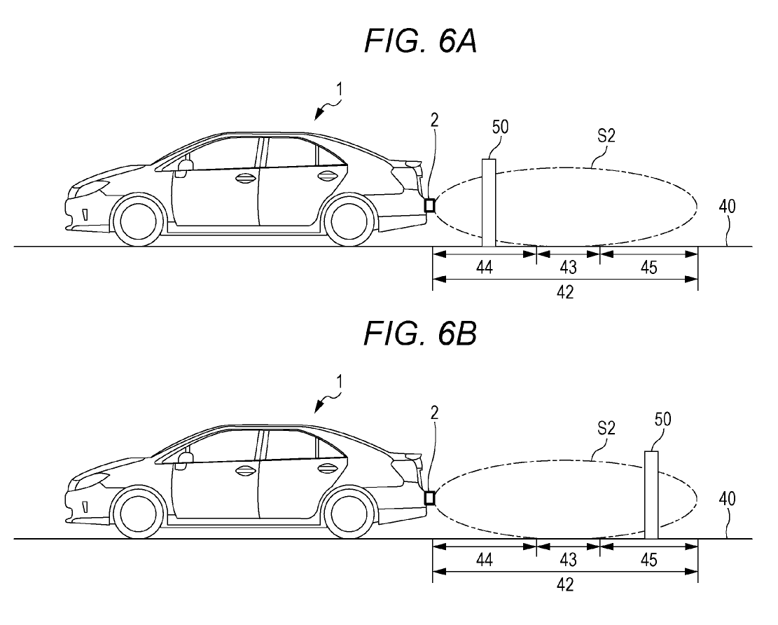

FIG. 6A and FIG. 6B are diagrams illustrating one example of the position of the obstacle detected in the long-distance transmission and reception mode. As illustrated in FIG. 6A, when obstacle 50 is in area 44 in the long-distance transmission and reception mode, obstacle 50 above area 44 is detected based on the second reflected wave from obstacle 50. Alternatively, as illustrated in FIG. 6B, when obstacle 50 is in area 45 in the long-distance transmission and reception mode, obstacle 50 above area 45 is detected based on the second reflected wave from obstacle 50. Note that as described above, since the second reflected wave including the road surface reflected wave does not undergo processing in the long-distance transmission and reception mode, the obstacle in area 43 is not detected in the long-distance transmission and reception mode, and the obstacle is detected in the normal transmission and reception mode.

When the obstacle is detected in the normal transmission and reception mode (step S103: normal), the flow proceeds to step S104. In this case, transmission and reception controller 11 outputs the control signal instructing continuation of the normal transmission and reception mode to each of signal transmitting circuit 20 and signal receiving circuit 30. Signal transmitting circuit 20 and signal receiving circuit 30 that receive the control signal continue the normal transmission and reception mode (step S104).

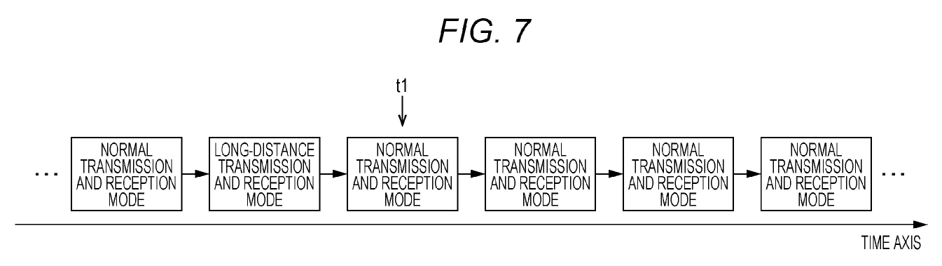

One example of continuation of the normal transmission and reception mode in step S104 will be described with reference to FIG. 7. As illustrated in FIG. 7, when the obstacle is detected at timing t1 (predetermined timing in the normal transmission and reception mode), subsequent switching to the long-distance transmission and reception mode is not executed, and the normal transmission and reception mode is continuously executed. The obstacle detected at timing t1 continues to be detected in the normal transmission and reception mode that continues.

Power consumption in the long-distance transmission and reception mode is larger than power consumption in the normal transmission and reception mode. Therefore, as described above, power consumption can be suppressed by detecting the obstacle detected in the normal transmission and reception mode in the normal transmission and reception mode that continues. In addition, in the long-distance transmission and reception mode, the obstacle above area 43 cannot be detected. Therefore, the obstacle can be securely detected continuously by detecting, in the normal transmission and reception mode that continues, the obstacle above area 43 detected in the normal transmission and reception mode.

On the other hand, when the obstacle is detected in the long-distance transmission and reception mode (step S103: long distance), the flow proceeds to step S105.

Then, detector 12 determines in which of area 44 and area 45 the obstacle is detected (step S105). As described above, detector 12 can determine where the received reflected wave is reflected. Therefore, when the received reflected wave is a reflected wave reflected in space above area 44, detector 12 determines that the obstacle is detected in area 44. On the other hand, when the received reflected wave is a reflected wave reflected in space above area 45, detector 12 determines that the obstacle is detected in area 45.

When the obstacle is detected in area 45 (step S105: area 45), the flow returns to step S101.

On the other hand, when the obstacle is detected in area 44 (step S105: area 44), the flow proceeds to step S106. In this case, transmission and reception controller 11 outputs the control signal for instructing continuation of the normal transmission and reception mode to each of signal transmitting circuit 20 and signal receiving circuit 30. Signal transmitting circuit 20 and signal receiving circuit 30 that receive the control signal continue the normal transmission and reception mode after switching from the long-distance transmission and reception mode to the normal transmission and reception mode (step S106).

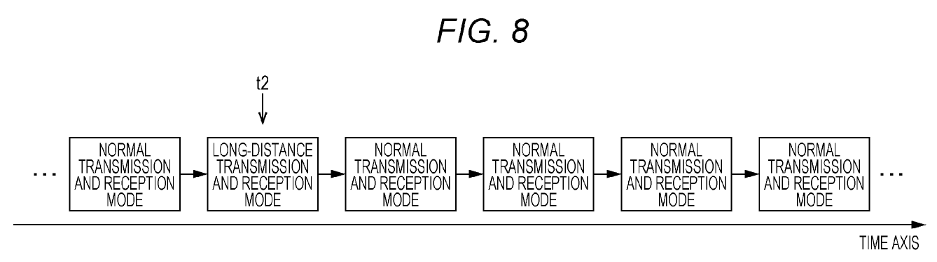

One example of continuation of the normal transmission and reception mode in step S106 will be described with reference to FIG. 8. As illustrated in FIG. 8, when the obstacle is detected at timing t2 (predetermined timing in the long-distance transmission and reception mode), after next switching to the normal transmission and reception mode, the normal transmission and reception mode is continuously executed. The obstacle detected at timing t2 continues to be detected in the normal transmission and reception mode that continues. Accordingly, effects similar to effects in a case of continuation of the normal transmission and reception mode in step S104 can be obtained.

Note that in step S104 or S106, continuous processing in the normal transmission and reception mode may be finished, for example, when the obstacle becomes undetected. In this case, the flow returns to processing of step S101 again.

The operation of detection device 100 has been described above.

As described in detail, detection device 100 of the present exemplary embodiment causes ultrasonic sensor 2 to alternately transmit the first transmission wave and the second transmission wave with different coverage, and detects presence of the obstacle based on the first reflected wave or the second reflected wave. This allows detection device 100 to detect the obstacle in a wider range and to detect the obstacle on the road surface accurately.

The present disclosure is not limited to the exemplary embodiment described above, and various modifications are possible. The modifications will be described below.

### First Modification

The above-described exemplary embodiment has described an example in which the normal transmission and reception mode and the long-distance transmission and reception mode are executed alternately in unit time of the same length, but the exemplary embodiment is not limited to this example.

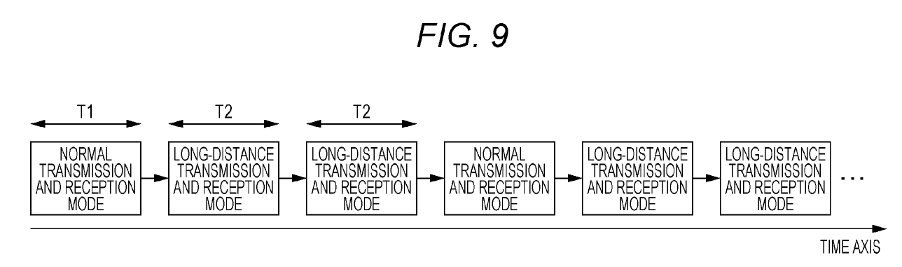

For example, execution time of the long-distance transmission and reception mode may be longer than execution time of the normal transmission and reception mode. This example will be described with reference to FIG. 9. In FIG. 9, unit time T1 has the same length as unit time T2 as in FIG. 3.

As illustrated in FIG. 9, whereas the normal transmission and reception mode is executed for unit time T1, the long-distance transmission and reception mode may be executed twice of unit time T2

According to the present modification, since the long-distance transmission and reception mode is executed for longer time than the normal transmission and reception mode, it becomes easy to detect the obstacle far from the vehicle (for example, area 45 illustrated in FIG. 2).

### Second Modification

In the above-described exemplary embodiment, for example, when the vehicle speed of vehicle 1 is higher than or equal to the threshold, transmission and reception controller 11 may output the control signal to instruct continuation of the long-distance transmission and reception mode to signal transmitting circuit 20 and signal receiving circuit 30. Note that transmission and reception controller 11 receives information indicating the vehicle speed of vehicle 1, for example, from an unillustrated vehicle speed sensor (the same applies hereinafter).

Alternatively, for example, when the distance between ultrasonic sensor 2 and the obstacle is longer than or equal to the threshold, transmission and reception controller 11 may output the control signal to instruct continuation of the long-distance transmission and reception mode to signal transmitting circuit 20 and signal receiving circuit 30.

Alternatively, for example, when the vehicle speed of vehicle 1 is higher than or equal to the threshold and the distance between ultrasonic sensor 2 and the obstacle is longer than or equal to the threshold, transmission and reception controller 11 may output the control signal to instruct continuation of the long-distance transmission and reception mode to signal transmitting circuit 20 and signal receiving circuit 30.

Signal transmitting circuit 20 and signal receiving circuit 30 that receive the control signal do not switch to the normal transmission and reception mode, and executes the long-distance transmission and reception mode continuously.

Note that instead of executing the long-distance transmission and reception mode continuously, as described in the first modification, execution time of the long-distance transmission and reception mode may be increased to be longer than execution time of the normal transmission and reception mode (refer to FIG. 9).

According to the present modification, when the vehicle speed of vehicle 1 is high, or there is an obstacle far from the vehicle (for example, area 45 illustrated in FIG. 2), or when the vehicle speed of vehicle 1 is high and there is an obstacle far from the vehicle, the obstacle can be detected easily.

In the above embodiment and modification, the switching between the transmission of the first transmission wave and the transmission of the second transmission wave may be not performed at the time of switching to the normal transmission mode or the long distance mode for each unit time, or the switching may be performed after the detection of an obstacle or detection that the vehicle speed is equal to or higher than the threshold value, the mode being executed at the time of detection is immediately terminated.

### INDUSTRIAL APPLICABILITY

The present disclosure is suitable for a detection device, a detection method, and a detection program for detecting an obstacle.

### REFERENCE MARKS IN THE DRAWINGS

1: vehicle
2: ultrasonic sensor
10: controller
11: transmission-and-reception controller
13: detector
18: transceiver
20: signal transmitting circuit
30: signal receiving circuit
40: road surface
41: area (area corresponding to coverage of first transmission wave)
42: area (area corresponding to coverage of second transmission wave)
43: area (partial area)
44: area (area close to vehicle)
45: area (area far from vehicle)
50: obstacle
100: detection device
S1: coverage (coverage of first transmission wave)
S2: coverage (coverage of second transmission wave)

1. A detection device comprising:
a transceiver that causes an ultrasonic sensor mounted on a vehicle to alternately transmit a first transmission wave having a first amplitude level and a second transmission wave having a second amplitude level that is greater than the first amplitude level, the transceiver receiving, from the ultrasonic sensor, a first received signal based on a first reflected wave of the first transmission wave and a second received signal based on a second reflected wave of the second transmission wave that are received by the ultrasonic sensor, the transceiver outputting at least one of the first received signal and the second received signal as a received signal; and
a detector that receives the received signal and detects an obstacle based on one of the first received signal and the second received signal, the one of the first received signal and the second received signal having a reception level of the received signal greater than a predetermined threshold,
wherein
the first amplitude level is set to make the reception level of the received signal based on a first road surface reflected wave reflected by a road surface out of the first reflected wave less than or equal to the predetermined threshold,
the second amplitude level is set to make the reception level of the received signal based on a second road surface reflected wave reflected by a partial area of the road surface out of the second reflected wave greater than the predetermined threshold, and
the detector determines based on which of the first received signal and the second received signal the obstacle is detected, and when the obstacle is detected based on the second received signal, the detector detects the obstacle based on a portion other than a portion received at timing when the second road surface reflected wave is received out of the second received signal.

2. The detection device according to claim 1, wherein a first time in which the first transmission wave is transmitted and the first received signal is received is identical to a second time in which the second transmission wave is transmitted and the second received signal is received.

3. The detection device according to claim 1, wherein a first time in which the first transmission wave is transmitted and the first received signal is received is shorter than a second time in which the second transmission wave is transmitted and the second received signal is received.

4. The detection device according to claim 1, wherein when the obstacle is detected based on the first received signal, the transceiver switches control of the ultrasonic sensor to cause the ultrasonic sensor to continuously transmit the first transmission wave.

5. The detection device according to claim 1, wherein when the obstacle is detected in an area closer to the vehicle than the partial area is based on the second received signal, the transceiver switches control of the ultrasonic sensor to cause the ultrasonic sensor to transmit the first transmission wave and to further cause the ultrasonic sensor to continuously transmit the first transmission wave.

6. The detection device according to claim 1, wherein when a vehicle speed of the vehicle becomes higher than or equal to a threshold, the transceiver switches control of the ultrasonic sensor to cause the ultrasonic sensor to transmit the second transmission wave and to further cause the ultrasonic sensor to continuously transmit the second transmission wave.

7. The detection device according to claim 1, wherein when the obstacle is detected in an area farther from the vehicle than the partial area is based on the second received signal, the transceiver switches control of the ultrasonic sensor to cause the ultrasonic sensor to continuously transmit the second transmission wave.

8. A detection method comprising:
transmitting and receiving to cause an ultrasonic sensor mounted on a vehicle to alternately transmit a first transmission wave having a first amplitude level and a second transmission wave having a second amplitude level that is greater than the first amplitude level, in the transmitting and receiving, receiving from the ultrasonic sensor, a first received signal based on a first reflected wave of the first transmission wave and a second received signal based on a second reflected wave of the second transmission wave that are received by the ultrasonic sensor, in the transmitting and receiving, outputting at least one of the first received signal and the second received signal as a received signal; and
detecting to receive the received signal and detecting an obstacle based on one of the first received signal and the second received signal, the one of the first received signal and the second received signal having a reception level of the received signal greater than a predetermined threshold,
wherein
the first amplitude level is set to make the reception level of the received signal based on a first road surface reflected wave reflected by a road surface out of the first received signal less than or equal to the predetermined threshold,
the second amplitude level is set to make the reception level of the received signal based on a second road surface reflected wave reflected by a partial area of the road surface out of the second received signal greater than the predetermined threshold, and
in the detecting, determining based on which of the first received signal and the second received signal the obstacle is detected, and when the obstacle is detected based on the second received signal, detecting the obstacle based on a portion other than a portion received at timing when the second road surface reflected wave is received out of the second received signal.

9. A non-transitory recording medium recording a program for causing a computer to execute:
transmission and reception processing for causing an ultrasonic sensor mounted on a vehicle to alternately transmit a first transmission wave having a first amplitude level and a second transmission wave having a second amplitude level that is greater than the first amplitude level, the transmission and reception processing receiving, from the ultrasonic sensor, a first received signal based on a first reflected wave of the first transmission wave and a second received signal based on a second reflected wave of the second transmission wave that are received by the ultrasonic sensor, the transmission and reception processing outputting at least one of the first received signal and the second received signal as a received signal; and
detection processing for receiving the received signal and detecting an obstacle based on one of the first received signal and the second received signal, the one of the first received signal and the second received signal having a reception level of the received signal greater than a predetermined threshold,
wherein
the first amplitude level is set to make the reception level of the received signal based on a first road surface reflected wave reflected by a road surface out of the first reflected wave less than or equal to the predetermined threshold,
the second amplitude level is set to make the reception level of the received signal based on a second road surface reflected wave reflected by a partial area of the road surface out of the second received signal greater than the predetermined threshold, and
the detection processing includes determining based on which of the first received signal and the second received signal the obstacle is detected, and when the obstacle is detected based on the second received signal, detecting the obstacle based on a portion other than a portion received at timing when the second road surface reflected wave is received out of the second received signal.
